(19) United States
(12) Patent Application Publication
(10) Pub. No.: US 2022/0076554 A1
(43) Pub. Date: Mar. 10, 2022

(54) Social Distancing and Contact Mapping Alerting Systems for Schools and other Social Gatherings

(71) Applicants: Erick Christopher Jones, SR., Arlington, TX (US); John Priest, Dallas, TX (US); Felicia Jefferson, McDonough, GA (US); Erick Christopher Jones, JR., Austin, TX (US); Gohar Azeem, Arlington, TX (US); Srinivas Annadurai, Arlington, TX (US)

(72) Inventors: Erick Christopher Jones, SR., Arlington, TX (US); John Priest, Dallas, TX (US); Felicia Jefferson, McDonough, GA (US); Erick Christopher Jones, JR., Austin, TX (US); Gohar Azeem, Arlington, TX (US); Srinivas Annadurai, Arlington, TX (US)

(21) Appl. No.: 17/013,944

(22) Filed: Sep. 8, 2020

(51) Int. Cl. G08B 21/04; H04W 4/02; G08B 25/00; G06K 9/00

(52) U.S. Cl. CPC G08B 21/0476; G08B 21/0453; G06K 9/00718; G08B 25/006; G06K 9/00778; H04W 4/023

(57) ABSTRACT

During a pandemic like COVID-19, real-time automated virus-monitoring and predictive models are crucial. The solution of this disclosure is through the development of a novel systems approach of implementing AI into visual cameras for visible characteristics such as facial and physical recognition and thermal imaging and other wavelength capture sensors such as thermal body characteristics which are then integrated with community mapping to resolve issues and predict trends before they happen. The system finds the distance between groups of people in classrooms, buildings, or other physical structures to locate pinch and possible virus contagion points in remote areas. Forehead to forehead measurement is one method as a novel approach to capture distance quickly. This is integrated into a distance statistical metric such as the Manhattan Distance Metric model to exemplify any two people who are less than 6 feet away and community mapping to identify and predict areas of concern.

### BACKGROUND OF INVENTION

Cameras are a technology that has existed for over a thousand years with the first photograph occurring in 1827 and has greatly improved with features and abilities even in just the last decade (Grepstad, 2006). Currently, the average resolution for off-the-shelf cameras is roughly 10 megapixels. Resolution determines how much detail can be visibly obtained in an image (Loebich, 2007). For the development of the social distancing alerting systems for schools and social gatherings, we have proposed the use of an AI-enabled camera and thermal camera that can detect the temperature of the students and supervise if they are keeping a safe distance from each other by analyzing real-time video streams from both the cameras. The detector could highlight students whose temperature is above the normal body temperature and whose distance is below the minimum acceptable distance in red and draw a line between to emphasize this. The system will also be able to issue an alert to remind students to keep a safe distance if the protocol is violated.

### BRIEF SUMMARY OF INVENTION

We seek to develop a Social Distancing and Contact Mapping Alerting device which includes an AI-enabled smart camera and a thermal camera to facilitate personnel identification, body temperature measurement, contact tracing, and community mapping. Ultimately, this device can be shipped to the schools, set up remotely at the classrooms, hallways, dorms, etc. and with the help of our software and apps, remotely monitor the students as the schools reopen across the United States. Our Artificial Intelligence software in conjunction with a targeted community map within the surveilled area will identify which communities within the school campus need to be prioritized and use the data collected by our devices to report to health departments. What is unique in our remote monitoring kit is our smart camera, which uses computer vision, machine learning, and AI algorithms to identify if the students are maintaining the social distancing protocol. We seek to capitalize on smart devices such as smartphones that can be alerted by the AI system in the form of a text message or an automated phone call.

### DETAILED DESCRIPTION OF THE INVENTION

Deep learning and machine learning are two related but different forms of AI. Machine learning is a way of training an algorithm by feeding it huge amounts of data as a method of training it to adjust itself to improve its performance. Deep learning is a different, more complex form of machine-learning-based artificial neural networks (ANNs), which mimic the structure of the human brain. Each ANN has distinct layers (each layer picks out a specific feature such as curve or edge in an image) with connections to other neurons. The more layers, the deeper the learning. Aside from the different types of machine learning used for AI in video surveillance, there are also different avenues of deployment, including on the edge (i.e., the camera) or the backend (i.e., the server), and on the physical network or through the cloud. We deploy it on the camera here which monitors students in the classroom.

Machine learning in Artificial Intelligence has many supervised and unsupervised algorithms that use Distance Metrics to understand patterns in the input data. Choosing a good distance metric will improve how well a classification or clustering algorithm is performed. A distance metric employs distance functions that tell us the distance between the elements in the dataset. Manhattan Distance metric is the most appropriate distance metric for our model as we want to calculate the distance between two points in a grid-like path where every data point has a set of numerical Cartesian coordinates that specify uniquely that point. These coordinates are a signed distance from the point to two fixed perpendicular oriented lines.

Our system's methodology consists of three main steps namely Calibration, Detection, and Measurement to implement social distancing among students in a classroom, dorm, and hallway, or in any other social gatherings.

As the input video from the camera may be taken from an arbitrary perspective view, the first step of the pipeline is computing the transform that morphs the perspective view into a bird's-eye (top-down) view. We term this process calibration. As the input frames are monocular (taken from a single camera), the simplest calibration method involves selecting four points in the perspective view and mapping them to the corners of a rectangle in the bird's-eye view. This assumes that every person is standing on the same flat ground plane. From this mapping, we can derive a transformation that can be applied to the entire perspective image. This method, while well-known, can be tricky to apply correctly. As such, we have built a lightweight tool that enables even non-technical users to calibrate the system in real-time. During the calibration step, we also estimate the scale factor of the bird's eye view, e.g. how many pixels correspond to 6 feet in real life.

The second step of the pipeline involves applying a human detector to the perspective views to draw a bounding box around each student. For simplicity, we use an open-source human detection network based on the Faster R-CNN architecture. To clean up the output bounding boxes, we apply minimal post-processing such as non-max suppression (NMS) and various rule-based heuristics. we should choose rules that are grounded in real-life assumptions (such as humans being taller rather than they are wide), to minimize the risk of overfitting.

Given the bounding box for each person now, we estimate their (x, y) location in the bird's-eye view. Since the calibration step outputs a transformation for the ground plane, we apply said transformation to the bottom-center point of each person's bounding box, resulting in their position in the bird's eye view. The last step is to compute the bird's eye view distance between every pair of people and scale the distances by the scaling factor estimated from calibration. We highlight people whose distance is below the minimum acceptable distance in red and draw a line between to emphasize this.

This product has the following components—
a. AI camera(s) and Thermal Camera(s) to continuously monitor the temperature of the students and check if the social distancing protocol is being followed.
b. Personnel Identification and Contact Tracing will be done using the AI software analyzing the real-time surveillance video streams.
c. Community maps will be created by using the pinch points. These community maps will lead to the creation of minority's maps which will drive the AI to look for social distancing in the most vulnerable area(s) of the school. This vulnerable area(s) will be found using AI learning algorithms and will be monitored on a cycle to reduce computing requirements. A response survey analysis system and mixed-integer programming will be used as inputs to the AI learning model.
d. The alerting system will create a noise alert in real-time to immediately have social distancing in an area where it is not followed. Along with this, the alerts will be sent as a text message to the students present in the vulnerable area.

The proposed system that uses AI cameras, hardware, and the software will work in an integrated form. An edge device is used to run multiple neural networks in parallel for applications like image classification, object detection, segmentation, and speech processing. All in an easy-to-use platform that runs in as little as 5 watts. An existing hardware infrastructure can be used which connects to the classroom camera and uses an edge device such as Jetson Nano or Google Coral Dev Board to monitor social distancing. A Smart Distancing, which is an open-source application can be used to quantify social distancing measures using edge computer vision systems. A Docker software must be installed on the device after which we can run this application on edge devices such as NVIDIA's Jetson Nano or Google's Coral Edge-TPU using Docker. It measures social distancing distances and gives proper notifications each time someone ignores social distancing rules. By generating and analyzing data, this solution outputs statistics about the communities that are at high risk of exposure to COVID-19 or any other contagious virus. Since all computation runs on the device, it requires minimal setup and minimizes privacy and security concerns. This model takes advantage of existing hardware infrastructure and state-of-the-art embedded edge devices, eliminating the need for IT Cloud infrastructure investment.

1. An apparatus for monitoring student(s) or any gathering of people's health, social distancing, and contact tracing comprising:
a surveillance camera(s);
a thermal imaging camera(s);
an accelerated machine learning processor(s); and
a platform to deliver AI software and communication alerts.

2. The apparatus recited in claim 1 wherein the surveillance camera(s) has a high definition wide lens.

3. The apparatus recited in claim 1 wherein the thermal imaging camera or other wavelength thermometers measure the temperature of the skin surface and other physical properties of a person without any contact.

4. The apparatus mentioned in claim 1 wherein the accelerated machine learning processor(s) uses complex artificial intelligence algorithms for image identification, classification, object detection, segmentation, and speech recognition.

5. The artificial intelligence algorithms as in claim 4 detect social distancing among students.

6. The social distancing detection as in claim 5 uses the artificial intelligence algorithms trained by a machine deep learning model(s) that analyzes real-time video streams of the students and grouped people.

7. The machine learning model as in claim 6 uses statistical methods such as the Manhattan Distance metric to calculate the distance between any two students.

8. The artificial intelligence algorithm as in claim 6 will provide an alert or a notification to the students and groups violating the social distancing protocol.

9. Alerts or notifications sent to the supervisory personal and students or groups who are violating the social distancing protocol as in claim 8 will be achieved by linking contact information with the artificial intelligence algorithm.

10. The apparatus mentioned in claim 1 wherein the surveillance camera(s) will record video and save the data which will be potentially used for contact tracing.

11. The apparatus mentioned in claim 1 wherein the platform to deliver software is an open platform for developing, shipping, and running applications.

12. The apparatus mentioned in claim 1 wherein the AI software will create the community maps using the pinch points.

13. The community maps as in claim 12 will drive the AI software to look for social distancing in the most vulnerable area(s).

14. The vulnerable area(s) as in claim 13 is found using by using response survey analysis and mixed-integer programming optimization.
